(19) United States
(12) Patent Application Publication
(10) Pub. No.: US 2008/0238110 A1
(43) Pub. Date: Oct. 2, 2008

(54) CASE LATCH ASSEMBLY

(75) Inventor: James Hatton, St. Leonards-on-sea (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: PENN FABRICATION LIMITED, St. Leonards-on-sea (GB)

(21) Appl. No.: 11/853,893

(22) Filed: Sep. 12, 2007

(30) Foreign Application Priority Data
Mar. 27, 2007 (EP) 07105056

(51) Int. Cl. E05C 3/14

(52) U.S. Cl. 292/203

(57) ABSTRACT

A case latch assembly 10 comprising a latch housing 12, a strike member 14 and a bolt assembly 16. The bolt assembly 16 comprises a bolt arm 30, mounting brackets 32, 34, spring members 36, 38 and a latch key 40. Each mounting bracket 32, 34 is generally z-shaped and comprises a mounting section 46, a fixing section 48 and an interconnecting section 50. Fixing ends 36a of the springs 36 are located through fixing apertures 54. The fixing sections 48 are separated such that they are spaced from the edges of the bolt arm 30 and the fixing ends 36a of the springs 36 are located between their fixing section 48 and the edge of the bolt arm 30. The bolt arm 30 is thus removed from the fixing ends 36a of the spring members 36, and can be provided close to the bottom of its housing 22, enabling the bolt assembly 16 to be fully received within the latch housing 12.

### TECHNICAL FIELD

The invention relates to a case latch assembly.

### BACKGROUND ART

Case latches for securing the lid and body of a case together are well known, for example the prior art latch disclosed in U.S. Pat. No. 5,511,834 (PENN FABRICATION (U.S.A) INC.) 30/04/1996. However, in known case latches the latch mechanism extends beyond the latch housing even when the latch is closed and locked, and accidental damage of the latch mechanism often occurs during transportation of the case on which the latch is provided and the protruding sections of the latch mechanism can present a hazard to people handling the case.

### DISCLOSURE OF INVENTION

According to an aspect of the present invention there is provided a case latch assembly comprising: a latch housing comprising a first housing part defining a first recess and a second housing part defining a second recess, the first and second recesses together forming a latch recess; a strike member provided on the first housing part and received within the first recess; a bolt assembly comprising: a mounting bracket provided on the second housing part and generally upstanding therefrom; a resilient member having a fixing end and a mounting end, the mounting end extending through a mounting slot in the mounting bracket at one end, and part way across the second recess, and the fixing end being received through a fixing aperture provided towards the other end of the bracket; a bolt arm pivotably mounted at one end on the mounting end and having strike plate engagement means at its distal end, the resilient member acting to retain the bolt arm in a closed position, and the bolt arm being reciprocally moveable between the closed position and an open position removed from the strike plate; and latch actuation means provided on the bolt arm, the case latch assembly characterised by the mounting bracket being generally z-shaped and comprising a mounting section at one end, a fixing section at the other end and an inter-connecting angled section, the mounting section being provided generally adjacent the one end of the bolt arm, the fixing aperature being provided on the fixing section and the fixing section being spaced from the bolt arm such that the fixing end of the resilient member is located between the fixing section and the edge of the bolt arm.

The bolt arm is thereby removed from the fixing end of the resilient member and does not overlay the fixing end of the resilient member. As a result, the pivot axis of the bolt arm can be positioned lower within the second recess, and thus the resilient member can be lowered within the second recess, and the position of the bolt arm and the latch actuation means within the second recess is consequently lowered. It is thus possible to fully receive the bolt assembly within the second recess, thereby protecting the bolt assembly from damage during use since no part of the bolt assembly extends beyond the second recess.

Preferably, the bolt assembly further comprises a second mounting bracket provided on the second housing part and generally upstanding therefrom, the mounting brackets being arranged in a spaced pair, and the bolt arm being receivable therebetween. The second mounting bracket is preferably generally z-shaped and comprises a mounting section at one end, a fixing section at the other end and an inter-connecting angled section, the mounting section being provided generally adjacent the one end of the bolt arm and having a mounting slot provided therein, and a fixing aperture being provided in the fixing section.

The bolt assembly preferably further comprises a second resilient member having a fixing end and a mounting end, the fixing end being received through the fixing aperture in the second mounting bracket and the mounting end extending through the mounting slot in the second mounting bracket and part way across the second recess, the fixing section of the second mounting bracket being spaced from the bolt arm such that the fixing end of the second resilient member is located between the fixing section and the edge of the bolt arm.

The bolt arm therefore does not overlay the fixing end of either resilient member, enabling the pivot axis of the bolt arm, the resilient member, and the position of the bolt arm and the latch key all still to be lowered within the second recess. It is thus possible to fully receive the bolt assembly within the second recess, thereby protecting the bolt assembly from damage during use since no part of the bolt assembly extends beyond the second recess.

Preferably, the mounting sections of the resilient members each extend part way across the space between the mounting brackets and the bolt arm is pivotably mounted on the mounting sections.

The or each resilient member is preferably arranged substantially flat to the bottom of the second recess. The or each resilient member preferably comprises a spring member and most preferably comprises a spiral metal spring.

By lowering the height of the pivot axis of the bolt arm, the height of the mounting ends of the or each resilient member is lowered enabling the resilient members to be arranged substantially flat to the bottom of the second recess. This reduces the height of the resilient members within the recess and ensures that the resilient members are fully received within the second recess.

The latch actuation means preferably comprises a latch actuation key. The latch actuation key is preferably pivotably mounted on the bolt arm, and is pivotable between an operating position in which it extends from the bolt arm and a closed position in which it is arranged generally adjacent the bolt arm.

Enabling the latch actuation key to be arranged generally adjacent the bolt arm when not in use further reduces the height of the bolt assembly and ensures that the bolt assembly is fully receivable within the second recess.

An embodiment of the invention will now be described in detail, by way of example only, with reference to the accompanying drawings.

### BRIEF DESCRIPTION OF FIGURES IN THE DRAWINGS

FIG. 1 is a diagrammatic plan view of a case latch assembly according to an embodiment of the invention, with the latch shown closed;

FIG. 2 is a diagrammatic side view of the case latch assembly of FIG.

FIG. 3 is a diagrammatic perspective view of the case latch assembly of FIG. 1; and

FIG. 4 is a diagrammatic perspective view of the case latch assembly of FIG. 1, with the latch shown open.

### MODE(S) FOR CARRYING OUT THE INVENTION

Referring to the drawings, an embodiment of the invention provides a case latch assembly 10 comprising a latch housing 12, a strike member 14 and a bolt assembly 16.

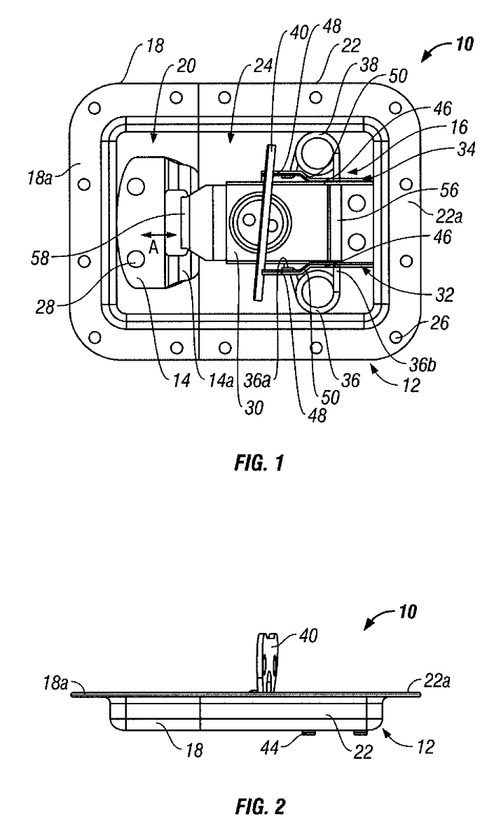

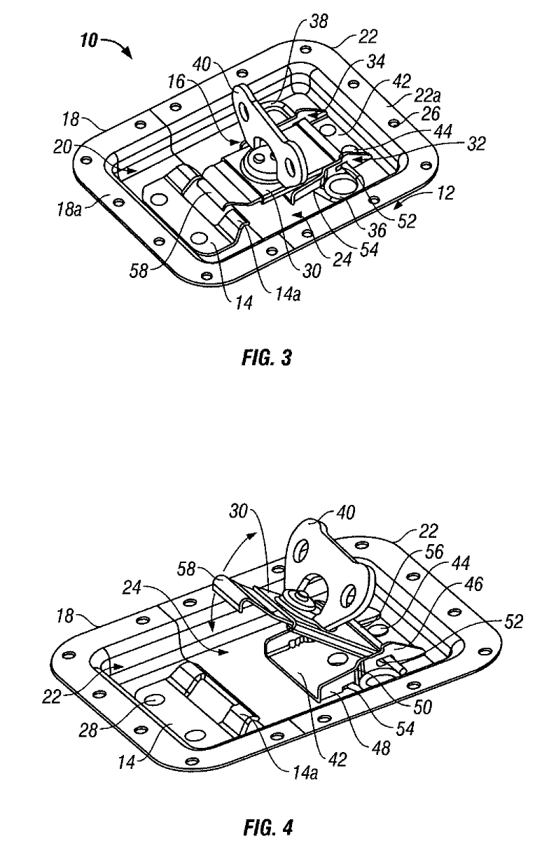

The latch housing 12 comprises a first part 18, which forms a strike member housing and defines a first recess 20, and a second part 22, which forms a bolt assembly housing and defines a second recess 24. When the strike member housing 18 and the bolt assembly housing 22 are arranged end-to-end, when the case is closed, as shown in FIG. 1, the first recess 20 and second recess 24 together define a latch recess of the latch housing 12. In this example, the housings 18, 22 comprise recessed half cups, fabricated from metal, and having fixing lips 18a, 22a in which holes 26 are provided for fastening, in this example riveting, the housings 18, 22 onto the lid and body of a case (not shown) respectively.

The strike member 14 is mounted on the strike member housing 18, at the bottom of the recess 20, by means of rivets 28. The strike member 14 includes a strike plate 14a for engagement with the bolt assembly 16, as shown in FIG. 1 and as will be described in more detail below. The strike member 14 is fully received within the recess 20 defined by the strike member housing 18, as shown in FIG. 2.

The bolt assembly 16 comprises a bolt arm 30, first and second mounting brackets 32, 34, first and second spring members 36, 38 and a latch actuation key 40.

The mounting brackets 32, 34 are provided on a bracket plate 42 which is mounted on the bolt assembly housing 22, at the bottom of the recess 24, by means of rivets 44. The mounting brackets 32, 34 extend generally upwardly from the bracket plate 42, and thus from the bottom of the housing 22. The height of the mounting brackets 32, 34 is less than the depth of the recess 24, so that the mounting brackets 32, 34 are fully received within the recess 24. The bolt arm 30 is located between the mounting brackets 32, 34, as will be described in more detail below.

Each mounting bracket 32, 34 is generally z-shaped, as seen best in FIG. 1, and comprises a mounting section 46 at one end, a fixing section 48 at the other end and an angled interconnecting section 50. A mounting slot 52 is provided in each mounting section 46 and a fixing aperture 54 is provided in each fixing section 48.

A fixing end 36a of each spring member 36 is located through its respective fixing aperture 54, and bent back against the respective fixing section 48, thereby securing the fixing ends 36a of the spring members 36. The other ends of the spring members 36 form mounting ends 36b. The mounting ends 36b are located though the mounting slots 52 in the respective mounting section 46 and extend part way across the recess 24 towards the opposing mounting bracket 32, 34. The spring members 36 lie substantially flat within the bolt assembly housing 22, at the bottom of the recess 24, so that they are fully received within the recess 24.

The bolt arm 30 is pivotably mounted at one end on the mounting ends 36b by means of a pivot channel 56 formed at the end of the bolt arm 30, through which the mounting ends 36b of the spring member 36 are located. A strike plate engagement lip 58 is provided at the other end of the bolt arm 30. The bolt arm 30 is reciprocally moveable within the bolt assembly housing 22 (as indicated by arrow A in FIG. 1) between a closed position, as shown in FIG. 1, in which the lip 58 can engage with the strike plate 14a, and an open position in which the lip 58 is removed from the strike plate 14a, allowing the bolt arm 30 to then pivot upwards (as orientated in the drawings), towards a latch open position, as shown in FIG. 4. The bolt arm 30 is moved from the closed position to the open position by a user manually engaging the key 40 and pulling against the force of the spring members 36, which act to retain the bolt arm 30 in the closed position.

The latch key 40 is pivotably mounted on the bolt arm 30 and is pivotable between an actuation position in which it extends outwardly from the bolt arm 30, as shown in the Figures, and a closed position in which it lies substantially flat against the bolt arm 30, within the second recess 24.

The mounting sections 46 are separated by a first distance, slightly larger than the width of the bolt arm 30, defining a gap into which the pivot end of the bolt arm 30 is closely received. By virtue of the angled interconnecting section 50, the fixing sections 48 are separated by a second, larger distance, such that they are spaced from the edges of the bolt arm 30 and the fixing ends 36a of the spring members 36 are located between their respective fixing section 48 and the respective edge of the bolt arm 30.

The bolt arm 30 is thus removed from the fixing ends 36a of the spring members 36, and the bolt arm 30 can be provided closer to the bottom of the bolt assembly housing 22 within the second recess 24 than is possible with the identified prior art latches. The height of the mounting ends 36b of the spring members 36, and thus the pivot axis of the bolt arm 30, can also be positioned lower within the second recess 24 than is possible with the identified prior art latches, which assists with lowering the position of the bolt arm 30. It is for this same reason that the spring members 36 can be arranged substantially flat to the bottom of the bolt assembly housing 22.

By spacing the fixing ends 36a of the spring member 36 from the bolt arm 30 in this manner therefore enables the bolt assembly 16 to be fully received within the second recess 24, thereby protecting the bolt assembly 16 from damage during use since, when the latch key 40 is folded flat against the bolt arm 30, no part of the bolt assembly 16 extends beyond the second recess 24.

Various modifications may be made to the described embodiment without departing from the scope of the invention. For example, the latch housing, strike member housing and/or bolt assembly housing may be of a different size and shape to that described. The strike plate may be of a different shape or configuration to that described. The bolt arm and the engagement lip may be of a different shape or configuration to that described. The spring members may be replaced by a different type of resilient member. The separation of the fixing sections and mounting sections may be different to that described, and the spacing between the fixing ends of the spring members and the edges of the bolt arm may be different to that described. The spaced pair of mounting brackets and pair of spring members may be replaced by a single mounting bracket and single spring member, and the length of the mounting end of the spring member may be longer in order to form an effective pivot pin for the bolt arm. The missing mounting bracket may be replaced by a retaining member for retaining the bolt arm in the required location. The latch actuation means may take a different form to the key described.

1. A case latch assembly (10) comprising: a latch housing (12) comprising a first housing part (18) defining a first recess (20) and a second housing part (22) defining a second recess (24), the first and second recesses together forming a latch recess; a strike member (14) provided on the first housing part and received within the first recess; a bolt assembly (16) comprising: a mounting bracket (32) provided on the second housing part and generally upstanding therefrom; a resilient member (36) having a fixing end (36a) and a mounting end (36b), the mounting end extending through a mounting slot (52) in the mounting bracket at one end, and part way across the second recess, and the fixing end being received through a fixing aperture (54) provided towards the other end of the bracket; a bolt arm (30) pivotably mounted at one end on the mounting end and having strike plate engagement means (58) at its distal end, the resilient member acting to retain the bolt arm in a closed position, and the bolt arm being reciprocally moveable between the closed position and an open position removed from the strike plate; and latch actuation means (40) provided on the bolt arm, the case latch assembly characterised by the mounting bracket being generally z-shaped and comprising a mounting section (46) at one end, a fixing section (48) at the other end and an inter-connecting angled section (50), the mounting section being provided generally adjacent the one end of the bolt arm, the fixing aperature being provided on the fixing section and the fixing section being spaced from the bolt arm such that the fixing end of the resilient member is located between the fixing section and the edge of the bolt arm.

2. A case latch assembly as claimed in claim 1, wherein the bolt assembly further comprises a second mounting bracket (34) provided on the second housing part and generally upstanding therefrom, the mounting brackets being arranged in a spaced pair, and the bolt arm being receivable therebetween.

3. A case latch assembly as claimed in claim 2, wherein the second mounting bracket is generally z-shaped and comprises a mounting section (46) at one end, a fixing section (48) at the other end and an inter-connecting angled section (50), the mounting section being provided generally adjacent the one end of the bolt arm and having a mounting slot (52) provided therein, and a fixing aperture (54) being provided in the fixing section.

4. A case latch assembly as claimed in claim 3, wherein the bolt assembly further comprises a second resilient member (36) having a fixing end (36a) and a mounting end (36b), the fixing end being received through the fixing aperture in the second mounting bracket and the mounting end extending through the mounting slot in the second mounting bracket and part way across the second recess, the fixing section of the second mounting bracket being spaced from the bolt arm such that the fixing end of the second resilient member is located between the fixing section and the edge of the bolt arm.

5. A case latch assembly as claimed in claim 4, wherein the mounting sections of the resilient members each extend part way across the space between the mounting brackets and the bolt arm is pivotably mounted on the mounting sections.

6. A case latch assembly as claimed in claim 1, wherein the or each resilient member is arranged substantially flat to the bottom of the second recess.

7. A case latch assembly as claimed in claim 1, wherein the latch actuation means comprises a latch actuation key.

8. A case latch assembly as claimed in claim 4, wherein the latch actuation key is pivotably mounted on the bolt arm, and is pivotable between an operating position in which it extends from the bolt arm and a closed position in which it is arranged generally adjacent the bolt arm.
